(19) United States
(12) Patent Application Publication
(10) Pub. No.: US 2025/0257002 A1
(43) Pub. Date: Aug. 14, 2025

(54) FLUOROPHOSPHATE GLASS, NEAR-INFRARED BLOCKING FILTER AND IMAGING DEVICE

(71) Applicant: AGC Inc., Tokyo (JP)

(72) Inventors: Kanako OHGUCHI, Shizuoka (JP); Takahiro SAKAGAMI, Shizuoka (JP)

(73) Assignee: AGC Inc., Tokyo (JP)

(21) Appl. No.: 19/196,886

(22) Filed: May 2, 2025

Related U.S. Application Data
(63) Continuation of application No. PCT/JP2023/039006, filed on Oct. 27, 2023.

(30) Foreign Application Priority Data
Nov. 18, 2022 (JP) 2022-185114

(51) Int. Cl. C03C 4/08; C03C 3/32

(52) U.S. Cl. CPC C03C 4/082; C03C 3/325

(57) ABSTRACT

The present invention relates to a fluorophosphate glass contains P, Cu, Mo, and F. A content ratio (Mo⁶⁺/Cu²⁺) of Mo⁶⁺ to Cu²⁺ is 0.01 to 0.39 on a mass basis. A content of Mo⁶⁺ may be 0.01 mass % to 4 mass %. A content of Cu²⁺ may be 1 mass % to 20 mass %.

### CROSS-REFERENCE TO RELATED APPLICATIONS

This is a bypass continuation of International Application No. PCT/JP2023/039006 filed on Oct. 27, 2023, and claims priority from Japanese Patent Application No. 2022-185114 filed on Nov. 18, 2022, the entire content of which is incorporated herein by reference.

### TECHNICAL FIELD

The present invention relates to a fluorophosphate glass, a near-infrared cut filter, and an imaging device, and more particularly, to a fluorophosphate glass that is used in a color correction filter for a solid-state imaging sensor such as a digital still camera and a color video camera and has excellent light transmittance in a visible region and excellent light absorbance in a near-infrared region, a near-infrared cut filter, and an imaging device.

### BACKGROUND ART

A solid-state imaging sensor such as a CCD or a CMOS used in a digital still camera or the like has a spectral sensitivity ranging from a visible region to a near-infrared region near 1200 nm. Therefore, since a solid-state imaging sensor cannot provide good color reproducibility as it is, a visual sensitivity of the solid-state imaging sensor is corrected by using a near-infrared cut filter glass to which a specific substance that absorbs an infrared ray is added.

As the near-infrared cut filter glass, an optical glass obtained by adding Cu to a fluorophosphate glass has been developed and used so as to selectively absorb a wavelength in a near-infrared region and have high weather resistance. Compositions of the glass are disclosed in Patent Literatures 1 to 3.

### CITATION LIST

### Patent Literature

Patent Literature 1: JPH01-219037A
Patent Literature 2: JP2004-83290A
Patent Literature 3: JP2004-137100A

### SUMMARY OF INVENTION

### Technical Problem

In recent years, PCs and cameras have become thinner and lighter, and with this, an ultra-wide angle of lens is required. As an angle of a lens becomes wider, a back focal length becomes shorter, so that there is a demand for a thinner near-infrared cut filter to be used therein.

However, when the near-infrared cut filter is made thinner, an amount of light absorbed by Cu²⁺ contained in the glass is reduced, and thus absorption of light having a wavelength in a near-infrared region is weakened. When an amount of Cu is increased in order to increase the amount of light absorbed by Cu²⁺, a content of Cu⁺ that absorbs light having a wavelength in a visible light region increases, and thus a transmittance of light in a visible region decreases.

When a melting temperature is lowered in order to obtain a high transmittance of light in the visible region, unmelted foreign matter from a raw material may be generated, or a melt may be non-uniform due to an increase in viscosity, resulting in a deterioration in quality.

The present invention has been made based on such a background, and an object of the present invention is to provide a fluorophosphate glass, a near-infrared cut filter, and an imaging device that can maintain a high transmittance of light in a visible region while keeping a transmittance of light in a near-infrared region low.

### Solution to Problem

As a result of intensive studies, the present inventors have found that in a fluorophosphate glass containing phosphorus (P) and fluorine (F), when molybdenum (Mo) is contained together with copper (Cu) and a content ratio of Cu and Mo is in a specific range, a fluorophosphate glass, a near-infrared cut filter, and an imaging device that can maintain a high transmittance of light in a visible region while keeping a transmittance of light in a near-infrared region low can be obtained.

That is, the present invention relates to the following.
(1) A fluorophosphate glass containing P, Cu, Mo, and F, in which a content ratio (Mo⁶⁺/Cu²⁺) of Mo⁶⁺ to Cu²⁺ is 0.01 to 0.39 on a mass basis.
(2) The fluorophosphate glass according to (1), in which a content of Mo⁶⁺ is 0.01 mass % to 4 mass %.
(3) The fluorophosphate glass according to (1), in which a content of Cu²⁺ is 1 mass % to 20 mass %.
(4) The fluorophosphate glass according to (1), further containing Na.
(5) The fluorophosphate glass according to (4), in which a content of Na⁺ is 0.1 mass % to 25 mass %.
(6) The fluorophosphate glass according to (1), containing, in terms of mass %,
P⁵⁺: 30% to 70%
Al³⁺: 0% to 20%
Li⁺: 0% to 20%
K⁺: 0% to 20%
Mg²⁺: 0% to 10%
Ca²⁺: 0% to 20%
Sr²⁺: 0% to 30%
Ba²⁺: 0% to 40%
ΣR⁺: 0.1% to 30% (R⁺ is one or more components selected from Li⁺, Na⁺, and K⁺), and
ΣR²⁺: 10% to 45% (R²⁺ is one or more components selected from Mg²⁺, Ca²⁺, Sr²⁺, and Ba²⁺), and containing 5 mass % to 70 mass % of F⁻ on an external basis.
(7) The fluorophosphate glass according to (1), in which a spectral transmittance at a wavelength of 420 nm is 85% or more in terms of a plate thickness of 0.1 mm.
(8) The fluorophosphate glass according to (1), in which a spectral transmittance at a wavelength of 1200 nm is 45% or less in terms of a plate thickness of 0.1 mm.
(9) The fluorophosphate glass according to (1), in which an average transmittance ratio A/B is 1.020 to 2.000, where A is an average transmittance of light in a wavelength of 450 nm to 500 nm and B is an average transmittance of light in a wavelength of 350 nm to 400 nm in terms of a plate thickness of 0.1 mm.
(10) A near-infrared cut filter including the fluorophosphate glass according to any one of (1) to (9).
(11) An imaging device including the near-infrared cut filter according to (10).

### Advantageous Effects of Invention

According to the present invention, a fluorophosphate glass, a near-infrared cut filter, and an imaging device that can maintain a high transmittance of light in a visible region while keeping a transmittance of light in a near-infrared region low can be provided.

### BRIEF DESCRIPTION OF DRAWINGS

FIG. 1 is a cross-sectional view of a near-infrared cut filter according to one embodiment of the present invention.

FIG. 2 is a cross-sectional view illustrating a modification of the near-infrared cut filter according to the embodiment of the present invention.

FIG. 3 is a cross-sectional view schematically illustrating an example of an imaging device using the near-infrared cut filter according to the embodiment of the present invention.

FIG. 4 is a graph illustrating a transmittance of light in a wavelength of 200 nm to 1200 nm in Example 9 (Working Example) and Example 19 (Comparative Example).

FIG. 5 is a graph illustrating a transmittance of light in a wavelength of 350 nm to 550 nm in Example 9 (Working Example) and Example 19 (Comparative Example).

### DESCRIPTION OF EMBODIMENTS

Hereinafter, modes for implementing the present invention are described in detail. The present invention is not limited to the following embodiments. The scale of the drawings is not necessarily accurate, and some features may be exaggerated or omitted.

In the description of the present application, “a to B” indicating a range means “a or more and β or less”.

### <Fluorophosphate Glass>

A fluorophosphate glass of an embodiment of the present invention (hereinafter, also referred to as fluorophosphate glass of the present embodiment or simply fluorophosphate glass or glass) contains P, Cu, Mo, and F, and a content ratio (Mo⁶⁺/Cu²⁺) of Mo⁶⁺ to Cu²⁺ is 0.01 to 0.39 on a mass basis.

In a fluorophosphate glass containing P and F, when Mo and Cu are contained and a content ratio of Cu and Mo is in a specific range, a high transmittance of light in a visible region can be maintained while keeping a transmittance of light in a near-infrared region low. The reason for this is not clear, but is presumed as follows.

That is, Cu is contained in the glass in a state of Cu²⁺ or Cu⁺, and Cu²⁺ is a component that absorbs light having a wavelength in the near-infrared region, and thus the transmittance of light in the near-infrared region is kept low, but Cu⁺ is a component that absorbs light having a wavelength in the visible light region, and thus the transmittance of light in the visible region is low. Here, Mo is known to exist in a glass as Mo⁶⁺ (hexavalent). However, when Mo and Cu are co-added in a fluorophosphate glass, Cu⁺ in the glass releases an electron (e) and becomes Cu²⁺ (Cu⁺→Cu²⁺+e⁻), and Mo⁶⁺ receives the electron released by Cu⁺ and becomes Mo⁵⁺ (pentavalent) (Mo⁶⁺+e⁻→Mo⁵⁺). Accordingly, a proportion of Cu⁺ (monovalent) that has an absorption characteristic in the vicinity of a wavelength of 300 nm to 600 nm decreases, and a transmittance of light in a wavelength of 400 nm to 540 nm increases. It is considered that since Mo⁵⁺ has a characteristic of absorbing light having a wavelength of about 400 nm, a transmittance of light having a wavelength of about 400 nm is not increased. In the related art, a fluorophosphate glass containing Cu and Mo has not been known, and the above is considered to be a new finding found by the present inventors. On the other hand, when a content of Mo increases, the influence of the absorption of light having a wavelength in the visible light region by Mo⁵⁺ increases, and the transmittance in the visible region decreases, and thus it is considered important to set the content ratio of Cu and Mo to a specific range.

The present invention is not to be construed as being limited to the above-described mechanism of action.

Each component that can form the fluorophosphate glass of the present embodiment and a suitable content thereof is described below. In the description of the present application, unless otherwise specified, the content of each component and the total content are expressed in terms of mass %. A transmittance of the glass in the present embodiment is intended to include a reflection characteristic of a glass surface (that is, not an internal transmittance of the glass).

In the fluorophosphate glass of the present embodiment, P is contained as P⁵⁺.

P⁵⁺ is a main component that forms the fluorophosphate glass, and is an essential component for improving a near-infrared ray cutting property. When a content of P⁵⁺ is 30% or more, the effect thereof can be sufficiently obtained, and when the content of P⁵⁺ is 70% or less, problems such as glass instability and deterioration in weather resistance are unlikely to occur. Therefore, the content of P⁵⁺ is preferably 30% to 70%. The content of P⁵⁺ is more preferably 32% or more, still more preferably 34% or more, even more preferably 35% or more, and most preferably 36% or more, and is more preferably 60% or less, still more preferably 50% or less, even more preferably 45% or less, and most preferably 43% or less.

As a raw material for P⁵⁺, from the viewpoint of preventing corrosion of a platinum crucible and preventing volatilization of the components, it is preferable to use phosphoric acid or phosphate.

In the fluorophosphate glass of the present embodiment, F is contained as F⁻.

F⁻ is an essential component for stabilizing the glass and improving the weather resistance. In the description of the present application, when component elements other than F⁻ contained in the glass are taken as 100 mass %, a content of F in the glass is expressed on an external basis.

The content of F⁻ is preferably 5% to 70% on an external basis. When the content of F⁻ is 5% or more on an external basis, the weather resistance effect is sufficient, and when the content of F⁻ is 70% or less on an external basis, problems such as a decrease in transmittance of light in the visible region, a decrease in mechanical properties such as strength, hardness, and elastic modulus, and an increase in ultraviolet ray transmittance are unlikely to occur. The content of F is more preferably 6% or more on an external basis, still more preferably 8% or more on an external basis, even more preferably 8.5% or more on an external basis, and most preferably 10% or more on an external basis, and is more preferably 60% or less on an external basis, still more preferably 50% or less on an external basis, even more preferably 40% or less on an external basis, and most preferably 25% or less on an external basis.

In the fluorophosphate glass of the present embodiment, Cu is contained as Cu⁺ or Cu²⁺, but in the description of the present application, the content is described as when all Cu existed as Cu²⁺.

Cu²⁺ is an essential component for cutting near-infrared rays. The content of Cu²⁺ is preferably 1% to 20%. When the content of Cu²⁺ is 1% or more, the effect thereof and the effect of increasing the transmittance of light in the visible region of the glass obtained when co-added with Mo can be sufficiently obtained, and when the content of Cu²⁺ is 20% or less, problems such as generation of devitrification impurities in the glass and a decrease in transmittance of light in the visible region are unlikely to occur. The content of Cu²⁺ is more preferably 2% or more, still more preferably 2.5% or more, even more preferably 3% or more, and most preferably 3.5% or more, and is more preferably 18% or less, still more preferably 16% or less, even more preferably 13% or less, and most preferably 11.5% or less.

The total Cu content is a total content of Cu expressed by mass %, including monovalent, divalent, and other existing valences. When the glass of the present embodiment (excluding the content of F) is taken as 100 mass %, the total Cu content in the glass is preferably in a range of 1 mass % to 20 mass %. When the total Cu content is 1 mass % or more, the effect of cutting near-infrared rays can be sufficiently obtained even when a plate thickness of the glass is small, and when the total Cu content is 20 mass % or less, a decrease in visible region transmittance can be prevented. The content of Cu⁺ expressed by mass % can be determined such that (Cu⁺/total Cu content)×100 [%] is in a range of 0.01% to 4.0%.

In the fluorophosphate glass of the present embodiment, Mo is contained as Mo⁵⁺ or Mo⁶⁺, but in the description of the present application, the content is described as when all Mo existed as Mo⁶⁺.

Mo⁶⁺ is an essential component for increasing the transmittance of light in the visible region of the glass. The present inventors prepared a fluorophosphate glass containing Cu and a fluorophosphate glass containing Cu and Mo, and confirmed optical properties thereof. As a result, the inventors confirmed that in the latter glass, a transmittance of light in a wavelength of 400 nm to 540 nm was significantly increased as compared with that in the former glass. As described above, this phenomenon, although hypothetical, is considered to be due to the following reasons.

Mo is known to exist in a glass as Mo⁶⁺ (hexavalent). However, when Mo and Cu are co-added in a phosphate glass, Cu⁺ in the glass releases an electron (e) and becomes Cu²⁺ (Cu⁺→Cu²⁺+e⁻), and Mo⁶⁺ receives the electron released by Cu⁺ and becomes Mo⁵⁺ (pentavalent) (Mo⁶⁺+e⁻→Mo⁵⁺). Accordingly, a proportion of Cu⁺ (monovalent) that has an absorption characteristic in the vicinity of a wavelength of 300 nm to 600 nm decreases, and a transmittance of light in a wavelength of 400 nm to 540 nm increases. It is considered that since Mo⁵⁺ has a characteristic of absorbing light having a wavelength of about 400 nm, a transmittance of light having a wavelength of about 400 nm is not increased.

The content of Mo⁶⁺ is preferably 0.01% to 4%. When the content of Mo⁶⁺ is 0.01% or more, the effect of increasing the transmittance of light in the visible region of the glass can be sufficiently obtained, and when the content of Mo⁶⁺ is 4% or less, problems such as deterioration in near-infrared ray cutting property and generation of devitrification impurities in the glass are unlikely to occur. The content of Mo⁶⁺ is more preferably 0.05% or more, still more preferably 0.1% or more, even more preferably 0.2% or more, and most preferably 0.3% or more, and is more preferably 3.5% or less, still more preferably 3% or less, even more preferably 2% or less, and most preferably 1% or less.

The content ratio (Mo⁶⁺/Cu²⁺) of Mo⁶⁺ to Cu²⁺ is 0.01 to 0.39 on a mass basis. When the content ratio is 0.01 or more, absorption of light having a wavelength in the visible light region by Cu⁺ can be sufficiently prevented, and absorption of light having a wavelength in the near-infrared region by Cu²⁺ can be sufficiently promoted. When the content ratio is 0.39 or less, deterioration in transmittance in the visible region by Mo⁵⁺ can be prevented. The content ratio (Mo⁶⁺/Cu²⁺) of Mo⁶⁺ to Cu²⁺, on a mass basis, is more preferably 0.02 or more, still more preferably 0.03 or more, even more preferably 0.05 or more, and most preferably 0.1 or more, and is more preferably 0.35 or less, still more preferably 0.3 or less, even more preferably 0.25 or less, and most preferably 0.2 or less.

Al³⁺ is a main component forming the glass, and is a component for enhancing strength of the glass, enhancing the weather resistance of the glass, and the like. In the case where the glass contains Al³⁺, when a content of Al³⁺ is 2% or more, the effect thereof can be sufficiently obtained, and when the content of Al³⁺ is 20% or less, problems such as glass instability and deterioration in near-infrared ray cutting property are unlikely to occur. The content of Al³⁺ is preferably 0% to 20%. The content of Al³⁺ is more preferably 2% or more, still more preferably 3% or more, even more preferably 3.5% or more, and most preferably 5% or more, and is more preferably 18% or less, still more preferably 15% or less, even more preferably 13% or less, and most preferably 10% or less.

As a raw material for Al³⁺, AlF₃, Al₂O₃, Al(OH)₃, and the like can be used. Among them, it is preferable to use AlF₃, since problems such as an increase in melting temperature, generation of unmelted matter, and glass instability due to a decrease in charged amount of F⁻ are unlikely to occur.

Li⁺ is a component for lowering the melting temperature of the glass, lowering the liquid phase temperature of the glass, stabilizing the glass, and the like. A content of Li⁺ is preferably 0% to 20%. When the content of Li⁺ is 20% or less, problems such as glass instability and deterioration in near-infrared ray cutting property are unlikely to occur. The content of Li⁺ is more preferably 1% or more, still more preferably 2% or more, even more preferably 4% or more, and most preferably 5% or more, and is more preferably 18% or less, still more preferably 15% or less, even more preferably 12% or less, and most preferably 10% or less.

In the fluorophosphate glass of the present embodiment, Na can be contained as Na⁺.

Na⁺ is a component for lowering the melting temperature of the glass, lowering the liquid phase temperature of the glass, stabilizing the glass, and the like. When the glass contains Na⁺, the effect of increasing the transmittance of light in the visible region of the glass obtained when co-added with Mo can be sufficiently obtained. A mechanism thereof is explained as follows. Oxygen ions are present around Cu⁺ in the fluorophosphate glass, and these oxygen ions are negatively charged. An electric field generated by the negative charges acts to inhibit the movement of electrons (e⁻) between Cu⁺ and Mo⁶⁺ (Cu⁺→Cu²⁺+e⁻) and (Mo⁶⁺+e⁻→Mo⁵⁺). Due to the presence of Na⁺ in the fluorophosphate glass, the negative charges of the oxygen ions are electrically neutralized by positive charges carried by Na⁺. As a result, the movement of electrons between Cu⁺ and Mo⁵⁺ is promoted, the proportion of Cu⁺ having light absorption characteristics in the visible region is reduced, and the light transmittance in the visible region is increased.

When the glass contains Na⁺, a content of Na⁺ is preferably 0.1% to 25%. When the content of Na⁺ is 25% or less, the glass is unlikely to become unstable. The content of Na⁺ is more preferably 0.5% or more, still more preferably 1% or more, even more preferably 2% or more, and most preferably 3% or more, and is more preferably 20% or less, still more preferably 18% or less, even more preferably 14% or less, and most preferably 10% or less.

A content ratio (Mo⁶⁺/Na⁺) of Mo⁶⁺ to Na⁺ is preferably 0.01 to 10 on a mass basis. Within the above range, the effect of increasing the transmittance of light in the visible region of the glass obtained when Mo⁶⁺ and Na⁺ are co-doped can be more sufficiently obtained. The content ratio (Mo⁶⁺/Na⁺) of Mo⁶⁺ to Na⁺, on a mass basis, is more preferably 0.03 or more, still more preferably 0.05 or more, even more preferably 0.08 or more, and most preferably 0.1 or more, and is more preferably 5 or less, still more preferably 3 or less, even more preferably 1.5 or less, and most preferably 1 or less.

K⁺ is a component having effects such as lowering the melting temperature of the glass and lowering the liquid phase temperature of the glass. A content of K⁺ is preferably 0% to 20%. The content of K⁺ is preferably 20% or less, since the glass is unlikely to become unstable. The content of K⁺ is more preferably 15% or less, still more preferably 10% or less, even more preferably 5% or less, and most preferably 3% or less.

R⁺ (one or more components selected from Li⁺, Na⁺, and K⁺) is a component for lowering the melting temperature of the glass, lowering the liquid phase temperature of the glass, stabilizing the glass, and the like. A total content of R⁺, that is, a total content (≥R⁺) of Li⁺, Na⁺, and K⁺, is preferably 0.1% or more, since the effect thereof can be sufficiently obtained, and the total content (ΣR⁺) is preferably 30% or less, since the glass is unlikely to become unstable. Therefore, the content of ΣR⁺ is preferably 0.1% to 30%. The content of ΣR⁺ is more preferably 1% or more, still more preferably 3% or more, even more preferably 5% or more, and most preferably 8% or more, and is more preferably 28% or less, still more preferably 25% or less, even more preferably 20% or less, and most preferably 13% or less.

Mg²⁺ is a component for lowering the melting temperature of the glass, lowering the liquid phase temperature of the glass, stabilizing the glass, increasing the glass strength, and the like. A content of Mg²⁺ is preferably 0% to 10%. When the content of Mg²⁺ is 10% or less, problems such as glass instability and deterioration in near-infrared ray cutting property are unlikely to occur. The content of Mg²⁺ is more preferably 8% or less, still more preferably 6% or less, even more preferably 5% or less, and most preferably 3% or less.

Ca²⁺ is a component for lowering the melting temperature of the glass, lowering the liquid phase temperature of the glass, stabilizing the glass, increasing the glass strength, and the like. A content of Ca²⁺ is preferably 0% to 20%. When the content of Ca²⁺ is 20% or less, problems such as glass instability and deterioration in near-infrared ray cutting property are unlikely to occur. The content of Ca²⁺ is more preferably 0.1% or more, still more preferably 1% or more, even more preferably 2% or more, and most preferably 3% or more, and is more preferably 18% or less, still more preferably 15% or less, even more preferably 10% or less, and most preferably 6% or less.

Sr²⁺ is a component for lowering the melting temperature of the glass, lowering the liquid phase temperature of the glass, stabilizing the glass, and the like. A content of Sr²⁺ is preferably 0% to 30%. When the content of Sr²⁺ is 30% or less, problems such as glass instability and deterioration in near-infrared ray cutting property are unlikely to occur. The content of Sr²⁺ is more preferably 0.1% or more, still more preferably 1% or more, even more preferably 3% or more, and most preferably 5% or more, and is more preferably 25% or less, still more preferably 20% or less, even more preferably 15% or less, and most preferably 10% or less.

Ba²⁺ is a component for lowering the melting temperature of the glass, lowering the liquid phase temperature of the glass, stabilizing the glass, and the like. A content of Ba²⁺ is preferably 0% to 40%. When the content of Ba²⁺ is 40% or less, problems such as glass instability and deterioration in near-infrared ray cutting property are unlikely to occur. The content of Ba²⁺ is more preferably 0.1% or more, still more preferably 5% or more, even more preferably 10% or more, and most preferably 15% or more, and is more preferably 35% or less, still more preferably 30% or less, even more preferably 25% or less, and most preferably 23% or less.

R²⁺ (one or more components selected from Mg²⁺, Ca²⁺, Sr²⁺, and Ba²⁺) is a component for lowering the melting temperature of the glass, lowering the liquid phase temperature of the glass, stabilizing the glass, and the like. When a total content of R²⁺, that is, a total content (ΣR²⁺) of Mg²⁺, Ca²⁺, Sr²⁺, and Ba²⁺, is 10% or more, the effect thereof is sufficiently obtained, and when the content of ΣR²⁺ is 45% or less, the glass is unlikely to become unstable. Therefore, the content of ΣR²⁺ is preferably 10% to 45%. The content of ΣR²⁺ is more preferably 15% or more, still more preferably 20% or more, even more preferably 23% or more, and most preferably 25% or more, and is more preferably 40% or less, still more preferably 35% or less, even more preferably 33% or less, and most preferably 30% or less.

Zn²⁺ has effects such as lowering the melting temperature of the glass and lowering the liquid phase temperature of the glass. A content of Zn²⁺ is preferably 0% to 30%. When the content of Zn²⁺ is 30% or less, problems such as glass instability, deterioration in solubility of the glass, and deterioration in near-infrared ray cutting property are unlikely to occur. The content of Zn²⁺ is more preferably 20% or less, still more preferably 15% or less, even more preferably 10% or less, and most preferably 5% or less.

Rb⁺ is a component having effects such as lowering the melting temperature of the glass and lowering the liquid phase temperature of the glass. A content of Rb⁺ is preferably 0% to 10%. When the content of Rb⁺ is 10% or less, the glass is unlikely to become unstable. The content of Rb⁺ is more preferably 8% or less, still preferably 6% or less, even more preferably 4% or less, and most preferably 2% or less.

Cs⁺ is a component having effects such as lowering the melting temperature of the glass and lowering the liquid phase temperature of the glass. A content of Cs⁺ is preferably 0% to 10%. When the content of Cs⁺ is 10% or less, the glass is unlikely to become unstable. The content of Cs⁺ is more preferably 8% or less, still more preferably 6% or less, even more preferably 4% or less, and most preferably 2% or less.

B³⁺ may be contained in a range of 20% or less in order to stabilize the glass. When a content of B³⁺ is 20% or less, problems such as deterioration in the weather resistance of the glass and deterioration in near-infrared ray cutting property are unlikely to occur. The content of B³⁺ is more preferably 15% or less, still more preferably 10% or less, even more preferably 8% or less, and most preferably 5% or less.

In the fluorophosphate glass of the present embodiment, SiO₂, GeO₂, ZrO₂, SnO₂, TiO₂, CeO₂, WO₃, Y₂O₃, La₂O₃, Gd₂O₃, Yb₂O₃, and Nb₂O₅ may be contained in a range of 10% or less in order to improve the glass weather resistance. When the content of these components is 10% or less, problems such as generation of devitrification impurities in the glass and deterioration in near-infrared ray cutting property are unlikely to occur. The content of the above components is preferably 4% or less, more preferably 3% or less, still more preferably 2% or less, and even more preferably 1% or less.

Any of Fe₂O₃, Cr₂O₃, Bi₂O₃, NiO, V₂O₅, MnO₂, and CoO is a component that reduces the transmittance of light in the visible region by being present in the glass. Therefore, it is preferable that these components are not substantially contained in the glass. Here, the expression “not substantially contained in the glass” means that the component is not contained except for unavoidable impurities, and means that the component is not actively added. Specifically, it means that the content of each of these components in the glass is about 100 ppm by mass or less.

In the fluorophosphate glass of the present embodiment, a coefficient of thermal expansion in a range of 30° C. to 300° C. is preferably 60×10⁻⁷/° C. to 180×10⁻⁷/° C., more preferably 65×10⁻⁷/° C. to 175×10⁻⁷/° C., and still more preferably 70×10⁻⁷/° C. to 170×10⁻⁷/° C.

When the fluorophosphate glass of the present embodiment is used for a color correction filter (a near-infrared cut filter glass) for a solid-state imaging sensor, the glass may be directly bonded to a packaging material since the glass also functions as a cover glass for hermetically sealing the solid-state imaging sensor. At this time, when a difference in coefficient of thermal expansion between the near-infrared cut filter glass and the packaging material is large, peeling or breakage may occur in a bonded portion, and an airtight state cannot be maintained.

Generally, materials such as glass, a crystallized glass, ceramics, and alumina are used as the packaging material in consideration of heat resistance, and it is preferable to reduce the difference in coefficient of thermal expansion between the packaging material and the near-infrared cut filter glass. Accordingly, the glass of the present embodiment preferably has a coefficient of thermal expansion in a temperature range of 30° C. to 300° C. within the above range.

The glass of the present embodiment preferably has a spectral transmittance of 85% or more at a wavelength of 420 nm in terms of a plate thickness of 0.1 mm. In this way, a glass having a high transmittance of light in the visible region is obtained. The above-described spectral transmittance is more preferably 87% or more, still more preferably 88% or more, and particularly preferably 88.3% or more. The above-described spectral transmittance can be measured by a method described in Examples.

The glass of the present embodiment preferably has a spectral transmittance of 45% or less at a wavelength of 1200 nm in terms of a plate thickness of 0.1 mm. In this way, a glass having a low transmittance of light in the near-infrared region is obtained. The above-described spectral transmittance is more preferably 40% or less, still more preferably 30% or less, and particularly preferably 25% or less. The above-described spectral transmittance can be measured by a method described in Examples.

The glass of the present embodiment preferably has an average transmittance of 88.5% or more for light in a wavelength of 450 nm to 500 nm in terms of a thickness of 0.1 mm. In this way, a glass having a high transmittance of light in the visible region is obtained. The above-described average transmittance of light is preferably 88.6% or more, more preferably 88.7% or more, even more preferably 88.8% or more, even more preferably 88.9% or more, and most preferably 89.0% or more. The average transmittance can be measured by a method described in Examples.

In the glass of the present embodiment, the average transmittance for light in a wavelength of 350 nm to 400 nm is preferably 89% or less in terms of a thickness of 0.1 mm. In this way, a glass having a low transmittance of light in an ultraviolet region is obtained. The above-described average transmittance of light is more preferably 88% or less, still more preferably 86% or less, even more preferably 84% or less, and most preferably 82% or less. The average transmittance can be measured by a method described in Examples.

In the glass of the present embodiment, an average transmittance ratio A/B is preferably 1.020 to 2.000, where A is an average transmittance of light in a wavelength of 450 nm to 500 nm and B is an average transmittance of light in a wavelength of 350 nm to 400 nm in terms of a thickness of 0.1 mm. When the glass of the present embodiment has such optical characteristics, ultraviolet rays can be cut while maintaining a high transmittance in the visible region, particularly of blue light. When the average transmittance ratio A/B is 1.020 or more, the above effect is more sufficiently obtained. When the average transmittance ratio A/B is 2.000 or less, the absorption of light in the ultraviolet region is less likely to spread to the visible region, and the transmittance of light in the visible region is less likely to decrease. In the glass of the present embodiment, the average transmittance ratio A/B is more preferably 1.030 to 1.800, still more preferably 1.050 to 1.600, even more preferably 1.060 to 1.400, and most preferably 1.080 to 1.300.

When the glass of the present embodiment is used for, for example, a color correction filter for a solid-state imaging sensor, the glass is generally used with a thickness of 2 mm or less. From the viewpoint of reducing the weight of the component, the thickness is preferably 1 mm or less, more preferably 0.5 mm or less, still more preferably 0.3 mm or less, and even more preferably 0.2 mm or less. From the viewpoint of ensuring the strength of the glass, the thickness thereof is preferably 0.05 mm or more.

The glass of the present embodiment can be produced, for example, as follows.

First, raw materials are weighed and mixed so as to fall within the above composition range (mixing step). The raw material mixture is accommodated in a platinum crucible, and heated and melted at a temperature of 750° C. to 1000° C. in an electric furnace (melting step). After being sufficiently stirred and refined, the raw material mixture is cast into a mold, cut and polished to form a flat plate having a predetermined thickness (molding step).

In the melting step of the above production method, the highest temperature of the glass during glass melting is preferably 1000° C. or lower. When the highest temperature of the glass during the glass melting is higher than the above temperature, transmittance characteristics may deteriorate. The above-described temperature is more preferably 970° C. or lower, still more preferably 950° C. or lower, and even more preferably 900° C. or lower.

When the temperature in the above melting step is too low, problems such as occurrence of devitrification during melting and requirement of a long time for burn through may occur, and thus the temperature is preferably 800° C. or higher, and more preferably 850° C. or higher.

The fluorophosphate glass of the present embodiment is formed into a predetermined shape, and then an optical multilayer film may be provided on at least one surface of the glass. Examples of the optical multilayer film include an IR cut film (a film reflecting near infrared rays), a UV/IR cut film (a film reflecting ultraviolet rays and near infrared rays), a UV cut film (a film reflecting ultraviolet rays), and an antireflection film. Such an optical thin film can be formed by a known method such as a vapor deposition method or a sputtering method.

An adhesion reinforcing film may be provided between the fluorophosphate glass of the present embodiment and the optical multilayer film. By providing the adhesion reinforcing film, the adhesion between the glass and the optical multilayer film is improved, and the film peeling can be prevented. Examples of the adhesion reinforcing film include silicon oxide (SiO₂), titanium oxide (TiO₂), lanthanum titanate (La₂Ti₂O₇), aluminum oxide (Al₂O₃), a mixture of aluminum oxide and zirconium oxide (ZrO₂), magnesium fluoride (MgF₂), calcium fluoride (CaF₂), strontium fluoride (SrF₂), and fluorine silicone. A substance containing fluorine or oxygen has higher adhesion, and magnesium fluoride and/or titanium oxide are particularly preferred as the adhesion reinforcing film since they have higher adhesion to glass or films. The adhesion reinforcing film may have a single layer or two or more layers. In the case of two or more layers, a plurality of substances may be combined.

### <Near-Infrared Cut Filter>

A near-infrared cut filter of the present embodiment contains the fluorophosphate glass of the present embodiment described above. Accordingly, a near-infrared cut filter that can maintain a high transmittance of light in a visible region (particularly blue light) while keeping a transmittance of light in a near-infrared region low can be obtained. The near-infrared cut filter of the present embodiment may have the following configuration in addition to the glass of the present embodiment.

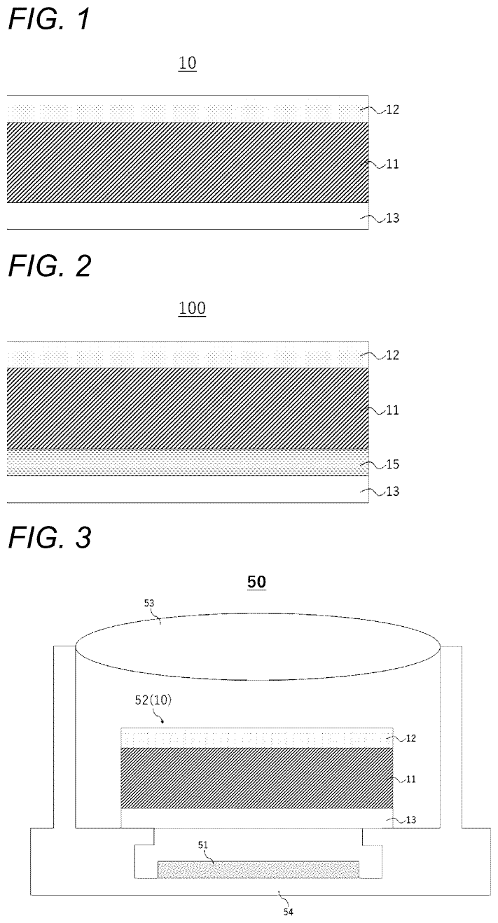

As illustrated in FIG. 1, a near-infrared cut filter 10 of the present embodiment may include the fluorophosphate glass 11 of the present embodiment, an infrared light reflection film 12 formed on one main surface of the fluorophosphate glass 11 and formed of a dielectric multilayer film that transmits light in a visible wavelength region but reflects light in an infrared wavelength region, and an antireflection film 13 formed on the other main surface of the fluorophosphate glass 11.

The infrared light reflection film 12 also has an effect of imparting or enhancing a near-infrared cut filter function. The infrared light reflection film 12 is formed of a dielectric multilayer film in which a low refractive index dielectric layer and a high refractive index dielectric layer are alternately laminated by a sputtering method, a vacuum deposition method, or the like.

As a material for the low refractive index dielectric layer, for example, a material having a refractive index of 1.6 or less, and preferably 1.2 to 1.6 is used. Specifically, silica (SiO₂), alumina, lanthanum fluoride, magnesium fluoride, sodium aluminum hexafluoride, or the like is used. As a material for the high refractive index dielectric layer, for example, a material having a refractive index of 1.7 or more, and preferably 1.7 to 2.5 is used. Specifically, titania (TiO₂), zirconia, tantalum pentoxide, niobium pentoxide, lanthanum oxide, yttria, zinc oxide, zinc sulfide, or the like is used. The refractive index is a refractive index for light having a wavelength of 550 nm.

The dielectric multilayer film can also be formed by an ion beam method, an ion plating method, a CVD method, or the like in addition to the sputtering method and the vacuum deposition method described above. The sputtering method and the ion plating method are a so-called plasma atmosphere treatment, and therefore can improve the adhesion to the fluorophosphate glass 11.

The antireflection film 13 has a function of improving a transmittance by preventing reflection of light incident on the near-infrared cut filter 10 and efficiently using the incident light, and can be formed by a material and a method that are known in related art. Specifically, the antireflection film 13 is made of one or more layers of silica, titania, tantalum pentoxide, magnesium fluoride, zirconia, alumina, or the like formed by a sputtering method, a vacuum deposition method, an ion beam method, an ion plating method, a CVD method, or the like, or a silicate-based, silicone-based, or fluoromethacrylate-based film formed by a sol-gel method, a coating method, or the like. A thickness of the antireflection film 13 is generally in a range of 100 nm to 600 nm.

In the near-infrared cut filter of the present embodiment, a second infrared light reflection film made of a dielectric multilayer film that reflects light in the infrared wavelength region may be provided on the main surface of the fluorophosphate glass 11 opposite to the main surface on which the infrared light reflection film 12 is formed, instead of the antireflection film 13, or between the antireflection film 13 and the fluorophosphate glass 11. The second antireflection film may be provided instead of the infrared light reflection film 12 or on the infrared light reflection film 12.

The near-infrared cut filter of the present embodiment may include an absorption layer containing a near-infrared absorbing material having a maximum absorption wavelength in the near-infrared region, on at least one main surface of the fluorophosphate glass of the present embodiment. With such a configuration, a near-infrared cut filter that keeps a transmittance of light in the near-infrared region low can be obtained.

When the near-infrared cut filter of the present embodiment includes the infrared light reflection film or the antireflection film, the near-infrared cut filter 100 may include the absorption layer 15 between the fluorophosphate glass 11 and the antireflection film 13, as illustrated in FIG. 2. The absorption layer 15 may be provided between the fluorophosphate glass 11 and the infrared light reflection film 12.

For the near-infrared cut filter of the present embodiment, it is preferable that a near-infrared ray absorbing dye is added to a transparent resin made of one kind of resins alone selected from an acrylic resin, an epoxy resin, an en-thiol resin, a polycarbonate resin, a polyether resin, a polyarylate resin, a polysulfone resin, a polyethersulfone resin, a polyparaphenylene resin, a polyarylene ether phosphine oxide resin, a polyimide resin, a polyamideimide resin, a polyolefin resin, a cyclic olefin resin, and a polyester resin or a transparent resin obtained by two or more kinds thereof, and is contained in an absorption layer.

As the near-infrared ray absorbing dye, it is preferable to use a near-infrared absorbing material including at least one selected from the group consisting of a squarylium dye, a phthalocyanine dye, a cyanine dye, and a diimmonium dye.

### <Imaging Device>

It is preferable that an imaging device according to the present invention includes the above-described near-infrared cut filter according to the present invention. It is preferable that the imaging device according to the present embodiment further includes a solid-state imaging sensor and an imaging lens in addition to the near-infrared cut filter according to the present embodiment. The near-infrared cut filter according to the present embodiment can be used, for example, by being disposed between the imaging lens and the solid-state imaging sensor, or by being directly attached to the solid-state imaging sensor, the imaging lens, or the like of the imaging device via an adhesive layer. By providing the near-infrared cut filter which is excellent in transmittance of visible light, has shielding properties of specific near-infrared light, and has a spectral curve hardly shifted even at a high incident angle, an imaging device excellent in color reproducibility even for light at a high incident angle can be obtained.

When the near-infrared cut filter is mounted on the imaging device, when the near-infrared cut filter includes the infrared light reflection film and the antireflection film, it is generally preferable that the near-infrared cut filter is mounted on the imaging device such that the infrared light reflection film is on an imaging lens side (an external light incident side) and the antireflection film is on a solid-state imaging sensor side.

For example, as illustrated in FIG. 3, an imaging device 50 according to the present embodiment may include a solid-state imaging sensor 51, a near-infrared cut filter 52, an imaging lens 53, and a housing 54 that holds and fixes these components.

As described above, the present description discloses the following.
(1) A fluorophosphate glass containing P, Cu, Mo, and F, in which a content ratio (Mo⁶⁺/Cu²⁺) of Mo⁶⁺ to Cu²⁺ is 0.01 to 0.39 on a mass basis.
(2) The fluorophosphate glass according to (1), in which a content of Mo⁶⁺ is 0.01 mass % to 4 mass %.
(3) The fluorophosphate glass according to (1) or (2), in which a content of Cu²⁺ is 1 mass % to 20 mass %.
(4) The fluorophosphate glass according to any one of (1) to (3), further containing Na.
(5) The fluorophosphate glass according to (4), in which a content of Na⁺ is 0.1 mass % to 25 mass %.
(6) The fluorophosphate glass according to any one of (1) to (5), containing, in terms of mass %,
P⁵⁺: 30% to 70%
Al³⁺: 0% to 20%
Li⁺: 0% to 20%
K⁺: 0% to 20%
Mg²⁺: 0% to 10%
Ca²⁺: 0% to 20%
Sr²⁺: 0% to 30%
Ba²⁺: 0% to 40%
ΣR⁺: 0.1% to 30% (R⁺ is one or more components selected from Li⁺, Na⁺, and K⁺), and
ΣR²⁺: 10% to 45% (R²⁺ is one or more components selected from Mg²⁺, Ca²⁺, Sr²⁺, and Ba²⁺), and
containing 5 mass % to 70 mass % of F⁻ on an external basis.
(7) The fluorophosphate glass according to any one of (1) to (6), in which a spectral transmittance at a wavelength of 420 nm is 85% or more in terms of a plate thickness of 0.1 mm.
(8) The fluorophosphate glass according to any one of (1) to (7), in which a spectral transmittance at a wavelength of 1200 nm is 45% or less in terms of a plate thickness of 0.1 mm.
(9) The fluorophosphate glass according to any one of (1) to (8), in which an average transmittance ratio A/B is 1.020 to 2.000, where A is an average transmittance of light in a wavelength of 450 nm to 500 nm and B is an average transmittance of light in a wavelength of 350 nm to 400 nm in terms of a plate thickness of 0.1 mm.
(10) A near-infrared cut filter including the fluorophosphate glass according to any one of (1) to (9).
(11) An imaging device including the near-infrared cut filter according to (10).

### EXAMPLES

Hereinafter, the present invention is described with reference to Examples, but the present invention is not limited to these Examples.

Working Examples and Comparative Examples of the fluorophosphate glass of the present invention are illustrated in Tables 1 and 2. Example 1 to Example 14 are Working Examples, and Example 15 to Example 20 are Comparative Examples.

### [Production of Glass]

For glasses in Examples 1 to 20, raw materials were weighed and mixed such that glass components after melting had compositions (mass %) illustrated in Tables 1 and 2. The mixture was charged in a platinum crucible having an internal volume of 1 L and melted in an electric furnace by heating for 2 hours at a melting temperature illustrated in each table. Thereafter, the mixture was refined, stirred, and cast into a rectangular mold having a length of 100 mm, a width of 80 mm, and a height of 20 mm that was preheated to about 50° C. to 500° C., then held at 300° C. to 500° C., and then slowly cooled at about 1° C./min to obtain a plate-shaped glass having a length of 40 mm, a width of 40 mm, and a thickness of 0.1 mm to 0.3 mm, both surfaces of which were optically polished.

Here, F⁻ is on an external basis.

The following raw materials were used as raw materials for each glass.
H₃PO₄ was used for P⁵⁺.
AlF₃ was used for Al³⁺.
LiF and LiNO₃ were used for Li⁺.
NaF was used for Na⁺.
KF was used for K⁺.
MgO was used for Mg²⁺.
CaF₂ was used for Ca²⁺.
SrF₂ was used for Sr²⁺.
BaF₂ was used for Ba²⁺.
CuO was used for Cu²⁺.
MoO₃ was used for Mo⁶⁺.

A fluoride raw material of the above components was used for F⁻.

In addition to the components described in Working Examples and Comparative

Examples, the glass contains O²⁻ as an anion. A content of O²⁻ is not illustrated since it varies depending on a content of highly volatile F, but all glasses in Working Examples and Comparative Examples contain O²⁻.

The raw materials of the glass are not limited to the above, and known materials can be used.

### [Evaluation]

A transmittance of the sample glass prepared as described above was measured. For the transmittance, a transmittance of light in a wavelength of 200 nm to 1200 nm was measured every 1 nm using a spectrophotometer (V-570, manufactured by JASCO Corporation) and converted to a value for a plate thickness of 0.1 mm. The obtained transmittance was first converted to an internal transmittance and then converted using the following formula.

Tᵢ₂=Tᵢ₁^{(t2/t1)}
Tᵢ₁: internal transmittance of actual sample (before conversion)
t1: plate thickness of actual sample
Tᵢ₂: internal transmittance after conversion
t2: plate thickness to be converted

Based on a transmittance of the converted internal transmittance (Tᵢ₂) including a reflection loss on front and back surfaces, a spectral transmittance at a wavelength of 1200 nm, a spectral transmittance at a wavelength of 420 nm, an average transmittance A of light in a wavelength of 450 nm to 500 nm, and an average transmittance B of light in a wavelength of 350 nm to 400 nm were obtained. The average transmittance ratio A/B was calculated based on the average transmittance A and the average transmittance B.

Results are illustrated in Tables 1 and 2.

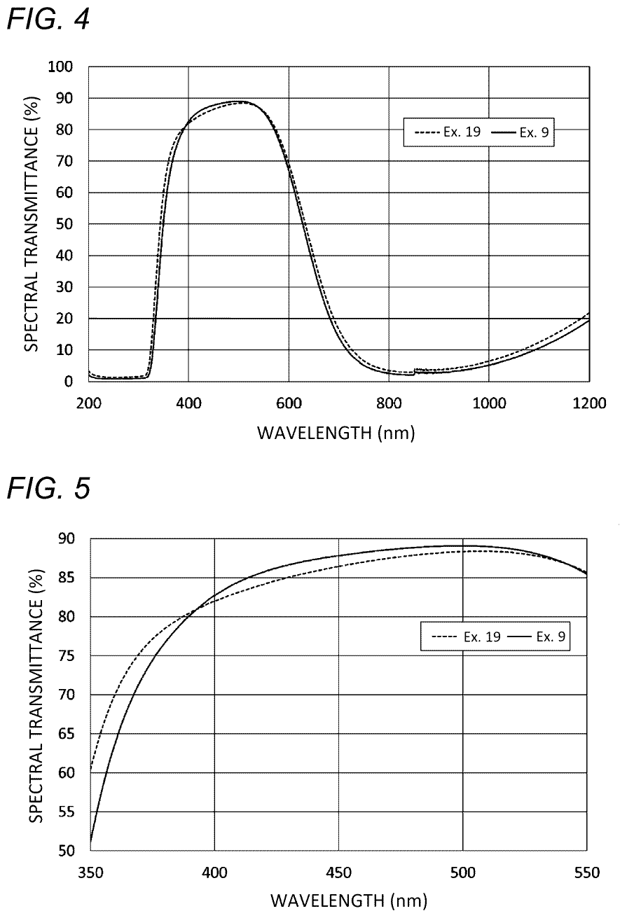

A transmittance of light in a wavelength of 200 nm to 1200 nm in Example 9 (Working Example) and Example 19 (Comparative Example) is illustrated in FIG. 4.

A transmittance of light in a wavelength of 350 nm to 550 nm in Example 9 (Working Example) and Example 19 (Comparative Example) is illustrated in FIG. 5.

TABLE 1

| | | | Example | Example | Example | Example | Example | Example |
|---|---|---|---|---|---|---|---|---|
| | | | 1 | 2 | 3 | 4 | 5 | 6 |
| Base glass | P⁵⁺ | mass % | 34.8 | 34.6 | 34.4 | 39.1 | 38.7 | 38.6 |
| | Al³⁺ | mass % | 10.0 | 10.0 | 10.0 | 7.6 | 7.7 | 7.5 |
| | Li⁺ | mass % | 5.0 | 5.0 | 5.0 | 6.6 | 6.7 | 6.5 |
| | Na⁺ | mass % | 8.7 | 8.7 | 8.9 | 4.2 | 4.1 | 4.1 |
| | K⁺ | mass % | 0.0 | 0.0 | 0.0 | 0.0 | 0.0 | 0.0 |
| | Mg²⁺ | mass % | 0.1 | 0.0 | 0.0 | 0.0 | 0.0 | 0.0 |
| | Ca²⁺ | mass % | 5.5 | 5.5 | 5.4 | 5.9 | 6.0 | 5.8 |
| | Sr²⁺ | mass % | 8.3 | 8.2 | 8.1 | 6.0 | 5.9 | 6.0 |
| | Ba²⁺ | mass % | 22.4 | 22.6 | 22.6 | 19.1 | 19.2 | 18.8 |
| | Cu²⁺ | mass % | 4.9 | 4.8 | 4.7 | 11.2 | 11.1 | 11.0 |
| | Mo⁶⁺ | mass % | 0.2 | 0.6 | 1.0 | 0.2 | 0.6 | 1.6 |
| | Total | mass % | 100 | 100 | 100 | 100 | 100 | 100 |
| External | F⁻ | mass % | 23.8 | 23.6 | 23.9 | 16.7 | 17.1 | 16.4 |
| percentage | | | | | | | | |
| Melting temperature | | ° C. | 840 | 840 | 840 | 870 | 870 | 870 |
| Plate thickness | | mm | 0.1 | 0.1 | 0.1 | 0.1 | 0.1 | 0.1 |
| Transmittance | 1200 nm | % | 64.18 | 64.03 | 64.34 | 40.43 | 40.46 | 39.30 |
| | 420 nm | % | 90.99 | 91.15 | 90.72 | 88.25 | 88.86 | 88.59 |
| | [A]Ave. (450 | % | 91.25 | 91.40 | 91.06 | 89.70 | 90.09 | 90.09 |
| | nm to 500 nm) | | | | | | | |
| | [B]Ave. (350 | % | 89.89 | 89.23 | 87.99 | 84.40 | 84.71 | 82.35 |
| | nm to 400 nm) | | | | | | | |
| | [A]/[B] | — | 1.02 | 1.02 | 1.03 | 1.06 | 1.06 | 1.09 |

| | | | | | | | |
|---|---|---|---|---|---|---|---|
| R⁺ (Li⁺ + Na⁺ + K⁺) | mass % | 13.7 | 13.7 | 13.8 | 10.8 | 10.8 | 10.6 |
| R²⁺ (Mg²⁺ + Ca²⁺ + Sr²⁺ + Ba²⁺) | mass % | 36.3 | 36.3 | 36.1 | 31.0 | 31.1 | 30.6 |
| Mo⁶⁺/Cu²⁺ | — | 0.04 | 0.12 | 0.20 | 0.02 | 0.06 | 0.14 |

| | | | Example | Example | Example | Example | Example |
|---|---|---|---|---|---|---|---|
| | | | 7 | 8 | 9 | 10 | 11 |
| Base glass | P⁵⁺ | mass % | 37.6 | 34.1 | 34.5 | 33.1 | 33.8 |
| | Al³⁺ | mass % | 7.5 | 5.2 | 5.2 | 7.1 | 7.1 |
| | Li⁺ | mass % | 6.4 | 0.0 | 0.0 | 4.8 | 4.8 |
| | Na⁺ | mass % | 4.2 | 16.2 | 15.6 | 1.4 | 1.4 |
| | K⁺ | mass % | 0.0 | 0.0 | 0.0 | 0.0 | 0.0 |
| | Mg²⁺ | mass % | 0.0 | 0.0 | 0.0 | 2.1 | 2.1 |
| | Ca²⁺ | mass % | 5.9 | 4.9 | 4.9 | 5.3 | 5.3 |
| | Sr²⁺ | mass % | 6.3 | 7.4 | 7.2 | 13.5 | 13.2 |
| | Ba²⁺ | mass % | 18.9 | 15.9 | 15.6 | 22.3 | 22.1 |
| | Cu²⁺ | mass % | 10.8 | 15.4 | 14.9 | 10.3 | 9.9 |
| | Mo⁶⁺ | mass % | 2.3 | 0.9 | 2.1 | 0.2 | 0.4 |
| | Total | mass % | 100 | 100 | 100 | 100 | 100 |
| External | F⁻ | mass % | 17.3 | 11.9 | 11.1 | 15.1 | 15.2 |
| percentage | | | | | | | |
| Melting temperature | | ° C. | 870 | 870 | 870 | 900 | 900 |
| Plate thickness | | mm | 0.1 | 0.1 | 0.1 | 0.1 | 0.1 |
| Transmittance | 1200 nm | % | 40.02 | 22.85 | 19.39 | 40.24 | 38.49 |
| | 420 nm | % | 88.28 | 87.24 | 85.73 | 87.37 | 86.34 |
| | [A]Ave. (450 | % | 89.95 | 89.48 | 88.61 | 89.19 | 88.46 |
| | nm to 500 nm) | | | | | | |
| | [B]Ave. (350 | % | 80.16 | 77.46 | 71.98 | 82.46 | 80.57 |
| | nm to 400 nm) | | | | | | |
| | [A]/[B] | — | 1.12 | 1.16 | 1.23 | 1.08 | 1.10 |

| | | | | | | |
|---|---|---|---|---|---|---|
| R⁺ (Li⁺ + Na⁺ + K⁺) | mass % | 10.6 | 16.2 | 15.6 | 6.2 | 6.2 |
| R²⁺ (Mg²⁺ + Ca²⁺ + Sr²⁺ + Ba²⁺) | mass % | 31.1 | 28.2 | 27.7 | 43.2 | 42.6 |
| Mo⁶⁺/Cu²⁺ | — | 0.21 | 0.06 | 0.14 | 0.02 | 0.04 |

TABLE 2

| | | | Example | Example | Example | Example | Example |
|---|---|---|---|---|---|---|---|
| | | | 12 | 13 | 14 | 15 | 16 |
| Base glass | P⁵⁺ | mass % | 34.4 | 34.2 | 33.4 | 34.7 | 34.4 |
| | Al³⁺ | mass % | 7.2 | 7.3 | 7.1 | 10.0 | 9.9 |
| | Li⁺ | mass % | 4.8 | 5.0 | 4.9 | 5.0 | 4.9 |
| | Na⁺ | mass % | 0.1 | 0.0 | 0.0 | 8.5 | 8.6 |
| | K⁺ | mass % | 0.0 | 0.0 | 0.0 | 0.0 | 0.0 |
| | Mg²⁺ | mass % | 2.1 | 0.0 | 2.2 | 0.1 | 0.0 |
| | Ca²⁺ | mass % | 5.3 | 5.4 | 5.3 | 5.5 | 5.4 |
| | Sr²⁺ | mass % | 13.2 | 14.0 | 13.6 | 8.5 | 8.0 |
| | Ba²⁺ | mass % | 22.6 | 23.0 | 22.5 | 22.8 | 22.1 |
| | Cu²⁺ | mass % | 10.2 | 10.6 | 10.4 | 4.9 | 4.7 |
| | Mo⁶⁺ | mass % | 0.1 | 0.6 | 0.6 | 0.0 | 1.9 |
| | Total | mass % | 100 | 100 | 100 | 100 | 100 |
| External | F⁻ | mass % | 13.7 | 15.2 | 15.6 | 23.5 | 24.0 |
| percentage | | | | | | | |
| Melting temperature | | ° C. | 900 | 900 | 900 | 840 | 840 |
| Plate thickness | | mm | 0.1 | 0.1 | 0.1 | 0.1 | 0.1 |
| Transmittance | 1200 nm | % | 36.94 | 35.54 | 38.13 | 63.95 | 65.06 |
| | 420 nm | % | 85.48 | 85.77 | 86.71 | 90.67 | 90.54 |
| | [A]Ave. (450 nm | % | 88.02 | 88.19 | 88.82 | 90.98 | 91.00 |
| | to 500 nm) | | | | | | |
| | [B]Ave. (350 nm | % | 78.80 | 79.17 | 81.03 | 89.84 | 85.80 |
| | to 400 nm) | | | | | | |
| | [A]/[B] | — | 1.12 | 1.11 | 1.10 | 1.01 | 1.06 |

| | | | | | | |
|---|---|---|---|---|---|---|
| R⁺ (Li⁺ + Na⁺ + K⁺) | mass % | 4.9 | 5.0 | 4.9 | 13.5 | 13.5 |
| R²⁺ (Mg²⁺ + Ca²⁺ + Sr²⁺ + Ba²⁺) | mass % | 43.2 | 42.4 | 43.6 | 36.8 | 35.5 |
| Mo⁶⁺/Cu²⁺ | — | 0.01 | 0.05 | 0.06 | 0.00 | 0.41 |

| | | | Example | Example | Example | Example |
|---|---|---|---|---|---|---|
| | | | 17 | 18 | 19 | 20 |
| Base glass | P⁵⁺ | mass % | 38.9 | 37.5 | 34.4 | 34.1 |
| | Al³⁺ | mass % | 7.8 | 7.3 | 5.2 | 7.1 |
| | Li⁺ | mass % | 6.7 | 6.3 | 0.0 | 4.8 |
| | Na⁺ | mass % | 4.2 | 4.0 | 16.3 | 1.3 |
| | K⁺ | mass % | 0.0 | 0.0 | 0.0 | 0.0 |
| | Mg²⁺ | mass % | 0.0 | 0.0 | 0.0 | 2.1 |
| | Ca²⁺ | mass % | 6.0 | 5.7 | 5.0 | 5.2 |
| | Sr²⁺ | mass % | 5.9 | 5.8 | 7.5 | 13.0 |
| | Ba²⁺ | mass % | 19.2 | 18.3 | 16.0 | 22.2 |
| | Cu²⁺ | mass % | 11.1 | 10.7 | 15.5 | 10.0 |
| | Mo⁶⁺ | mass % | 0.0 | 4.3 | 0.0 | 0.0 |
| | Total | mass % | 100 | 100 | 100 | 100 |
| External | F⁻ | mass % | 19.0 | 16.5 | 12.0 | 15.1 |
| percentage | | | | | | |
| Melting temperature | | ° C. | 870 | 870 | 870 | 900 |
| Plate thickness | | mm | 0.1 | 0.1 | 0.1 | 0.1 |
| Transmittance | 1200 nm | % | 40.51 | 39.51 | 21.69 | 38.45 |
| | 420 nm | % | 88.18 | 87.25 | 84.16 | 86.25 |
| | [A]Ave. (450 nm | % | 89.82 | 89.48 | 87.59 | 88.56 |
| | to 500 nm) | | | | | |
| | [B]Ave. (350 nm | % | 84.16 | 75.37 | 75.26 | 80.40 |
| | to 400 nm) | | | | | |
| | [A]/[B] | — | 1.07 | 1.19 | 1.16 | 1.10 |

| | | | | | |
|---|---|---|---|---|---|
| R⁺ (Li⁺ + Na⁺ + K⁺) | mass % | 11.0 | 10.3 | 16.3 | 6.2 |
| R²⁺ (Mg²⁺ + Ca²⁺ + Sr²⁺ + Ba²⁺) | mass % | 31.2 | 29.8 | 28.5 | 42.6 |
| Mo⁶⁺/Cu²⁺ | — | 0.00 | 0.40 | 0.00 | 0.00 |

In Examples 1 to 3, which were Working Examples, Mo was added such that the Mo⁶⁺/Cu²⁺ was within the range of 0.01 to 0.39 with respect to Example 15, which was a Comparative Example, and thus Examples 1 to 3 had an improved spectral transmittance at 420 nm as compared with Example 15. On the other hand, in Example 16, which was a Comparative Example, Mo was added such that the Mo⁶⁺/Cu²⁺ ratio exceeded 0.39 with respect to Example 15, which was a Comparative Example, and thus Example 16 had an inferior spectral transmittance at 420 nm as compared with Example 15.

In Examples 4 to 7, which were Working Examples, Mo was added such that the Mo⁶⁺/Cu²⁺ was within the range of 0.01 to 0.39 with respect to Example 17, which was a Comparative Example, and thus Examples 4 to 7 had an improved spectral transmittance at 420 nm as compared with Example 17. In Examples 4 to 7, which were Working Examples, the spectral transmittance at a wavelength of 1200 nm could be kept low. On the other hand, in Example 18, which was a Comparative Example, Mo was added such that the Mo⁶⁺/Cu²⁺ ratio exceeded 0.39 with respect to Example 17, which was a Comparative Example, and thus Example 18 had an inferior spectral transmittance at 420 nm as compared with Example 17.

In Examples 8 and 9, which were Working Examples, Mo was added such that the Mo⁶⁺/Cu²⁺ was within the range of 0.01 to 0.39 with respect to Example 19, which was a Comparative Example, and thus Examples 8 and 9 had an improved spectral transmittance at 420 nm as compared with Example 19.

In Examples 10 and 11, which were Working Examples, Mo was added such that the Mo⁶⁺/Cu²⁺ was within the range of 0.01 to 0.39 with respect to Example 20, which was a Comparative Example, and thus Examples 10 and 11 had an improved spectral transmittance at 420 nm as compared with Example 20.

In Examples 12 to 14, which were Working Examples, the Mo⁶⁺/Cu²⁺ was in the range of 0.01 to 0.39, and the spectral transmittance at a wavelength of 1200 nm could be kept low while maintaining the spectral transmittance at 420 nm to be high.

Although various embodiments have been described above with reference to the drawings, it is needless to say that the present invention is not limited to such examples. It is obvious for a person skilled in the art that various modifications and variations can be made within the category described in the scope of claims and it is understood that such modifications and variations naturally belong to the technical scope of the present invention. Further, the components described in the above embodiment may be combined in any manner without departing from the spirit of the invention.

The present application is based on a Japanese Patent Application (No. 2022-185114) filed on Nov. 18, 2022, contents of which are incorporated herein by reference.

### REFERENCE SIGNS LIST

10, 100 near-infrared cut filter
11 fluorophosphate glass
12 infrared light reflection film
13 antireflection film
15 absorption layer
50 imaging device
51 solid-state imaging sensor
52 near-infrared cut filter
53 imaging lens
54 housing

1. A fluorophosphate glass comprising P, Cu, Mo, and F,
wherein a content ratio (Mo⁶⁺/Cu²⁺) of Mo⁶⁺ to Cu²⁺ is 0.01 to 0.39 on a mass basis.

2. The fluorophosphate glass according to claim 1, wherein a content of Mo⁶⁺ is 0.01 mass % to 4 mass %.

3. The fluorophosphate glass according to claim 1, wherein a content of Cu²⁺ is 1 mass % to 20 mass %.

4. The fluorophosphate glass according to claim 1, further comprising Na.

5. The fluorophosphate glass according to claim 4, wherein a content of Na⁺ is 0.1 mass % to 25 mass %.

6. The fluorophosphate glass according to claim 1, comprising, in terms of mass %,
P⁵⁺: 30% to 70%
Al³⁺: 0% to 20%
Li⁺: 0% to 20%
K⁺: 0% to 20%
Mg²⁺: 0% to 10%
Ca²⁺: 0% to 20%
Sr²⁺: 0% to 30%
Ba²⁺: 0% to 40%
ΣR⁺: 0.1% to 30% (R⁺ is one or more components selected from Li⁺, Na⁺, and K⁺), and
ΣR²⁺: 10% to 45% (R²⁺ is one or more components selected from Mg²⁺, Ca²⁺, Sr²⁺, and Ba²⁺), and
comprising 5 mass % to 70 mass % of F⁻ on an external basis.

7. The fluorophosphate glass according to claim 1, wherein a spectral transmittance at a wavelength of 420 nm is 85% or more in terms of a plate thickness of 0.1 mm.

8. The fluorophosphate glass according to claim 1, wherein a spectral transmittance at a wavelength of 1200 nm is 45% or less in terms of a plate thickness of 0.1 mm.

9. The fluorophosphate glass according to claim 1, wherein an average transmittance ratio A/B is 1.020 to 2.000, where A is an average transmittance of light in a wavelength of 450 nm to 500 nm and B is an average transmittance of light in a wavelength of 350 nm to 400 nm in terms of a plate thickness of 0.1 mm.

10. A near-infrared cut filter comprising the fluorophosphate glass according to claim 1.

11. An imaging device comprising the near-infrared cut filter according to claim 10.
